(19) United States
(12) Patent Application Publication
(10) Pub. No.: US 2024/0414651 A1
(43) Pub. Date: Dec. 12, 2024

(54) WIRELESS DEVICE, NETWORK NODE, AND METHODS PERFORMED THEREIN DURING DISCONTINOUS RECEPTION (DRX)

(71) Applicant: Telefonaktiebolaget LM Ericsson (publ), Stockholm (SE)

(72) Inventors: Du Ho KANG, Sollentuna (SE); Jose Luis PRADAS, Stockholm (SE)

(21) Appl. No.: 18/705,834

(22) PCT Filed: Nov. 3, 2022
(86) PCT No.: PCT/SE2022/051008

§ 371 Date: Apr. 29, 2024

Related U.S. Application Data
(60) Provisional application No. 63/275,107, filed on Nov. 3, 2021.

(51) Int. Cl. H04W 52/02; H04W 76/28

(52) U.S. Cl. CPC H04W 52/0235; H04W 76/28

(57) ABSTRACT

A method, system and apparatus are disclosed. According to one or more embodiments, a method implemented in a wireless device that is configured to communicate with a network node is provided. The method comprises receiving an indication to cause the wireless device to, during an active time of a discontinuous reception, DRX, period, enter a sleep state after a physical downlink shared channel, PDSCH, reception at the wireless device; receiving the PDSCH; and entering the sleep state during the active time of the DRX period according to the indication. The indication is included in a physical downlink control channel, PDCCH.

### TECHNICAL FIELD

The present disclosure relates to wireless communications, and in particular, to a wireless device, a network node, and methods performed therein for wireless communications during discontinuous reception.

### BACKGROUND

The 3^{rd} Generation Partnership Project (3GPP) Firth Generation (5G) New Radio (NR) set of standards is designed to support applications demanding high rate and low latency in line with the requirements posed by the support of XR (e.g., extended reality) and cloud gaming applications in NR networks. Third Generation Partnership Projection (3GPP) Release 17 contains a study item on XR Evaluations for NR. Some objectives of the study item are to identify the traffic model for each application of interest, the evaluation methodology and the key performance indicators of interest for relevant deployment scenarios, and to carry out performance evaluations accordingly in order to investigate possible standardization enhancements in potential follow-up study item (SI)/work item (WI).

### Low-Latency High-Rate Applications

The low-latency applications like XR and cloud gaming benefit from bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

FIG. 1 is a graph showing an example of frame latency measured over radio access network (RAN), excluding application & core network latencies. As illustrated, there exist frame latency spikes in RAN. The sources for the latency spikes may include queuing delay, time-varying radio environments, time-varying frame sizes, among others. For example, latency spikes occur due to instantaneous shortage of radio resources or inefficient radio resource allocation in response to varying frame size. Some tools that can help to remove latency spikes may help enable better 5G support for this type of traffic.

In addition to bounded latency requirements, applications like XR and cloud gaming also require high rate transmission. This can be from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

A large video frame is usually fragmented into smaller IP packets and transmitted as several transport blocks (TBs) over several TTIs in RAN. FIG. 2 is a graph of an example of the cumulative distribution functions of the number of transport blocks required to deliver a video frame with size ranging from 20 KB to 300 KB. For example, FIG. 2 illustrates that for delivering the frames with a size of 100 KB each, the median number of needed TBs is 5.

### Power Considerations for XR and Cloud Gaming

In addition to Smartphone based XR, XR experience is increasingly expected to be delivered via Head Mounted Displays (HMDs). The power considerations for HMDs are different from those of Smartphones. In particular, the power dissipation of Augmented Reality (AR) glasses can be significantly lower than that of a smartphone, if the AR glass form factor is similar to that of prescription glasses and is expected to be worn for long durations. The AR glasses can have an embedded 5G modem providing 5G connectivity, or the AR glasses can be tethered (USB, Bluetooth, or WiFi) to a Smartphone for 5G connectivity. In both cases, the 5G connection carries AR application traffic, and the wireless device power consumption from that traffic has a significant bearing on the viability of such AR glasses products.

Further, the AR computation can be split between the AR glasses and Edge servers. The computation split can reduce the overall power consumption on the device (e.g., AR device, type of wireless device) if the resulting traffic from the computation split does not increase the wireless device power consumption significantly.

In cases of Cloud Gaming, the wireless device is generally expected to be a Smartphone or Tablet. The power consumption and battery life of the wireless device for a long duration Cloud Gaming experience is an aspect to consider.

As such, power consumption is a factor for XR and Cloud Gaming.

### DRX Mechanism

The 3GPP specifications for NR and Long Term Evolution (LTE, also referred to as 4^{th} Generation (4G)) specify procedures for discontinuous reception (DRX), which is adopted as an effective power saving mechanism. The DRX mechanism allows the wireless device to save battery power by monitoring the downlink (DL) control channel less frequently and go to “sleep” whenever there is no packet activity for the wireless device. DRX can be configured in Radio Resource control (RRC)_IDLE mode and/or in RRC_CONNECTED mode independently.

FIG. 3 is a diagram of an example of a simplified version of the DRX operation. The DRX cycle, drx_onDuration Timer and drx_Inactivity Timer are configured by RRC and the values are fixed, i.e., they are not dynamically changed or adjusted. The “Active Time” is the period of time in which the wireless device monitors physical downlink control channel (PDCCH) within a DRX cycle, which is the period of time while drx-onDurationTimer or drx-Inactivity Timer is running. The “Active Time” may also be affected by other timers. There are two DRX operation modes: short and long DRX cycles. The network (e.g., network node) via RRC signaling configures the wireless device DRX parameters and the DRX operation mode, Short DRX and/or Long DRX. During the time the drx_OnDuration Timer is running, the wireless device monitors PDCCH. If the wireless device successfully decodes a PDCCH, the wireless device starts the drx_Inactivity Timer. If no new PDCCH is received while any of the two timers is running, the wireless device moves into the “sleep period” in which the wireless device does not monitor PDCCH until the next DRX cycle.

Mechanisms to switch between long DRX and short DRX cycles have been introduced as well as mechanisms to stop the drx_OnDurantionTimer and drx_Inactivity Timer. MAC Control Element commands: DRX Command MAC CE and Long DRX Command MAC CE relate to these mechanisms. These mechanisms allow the wireless device to stop the PDCCH monitoring period and go to the “sleep period” which shortens the wireless device power consumption. FIG. 4 is a diagram of an example in which MAC CE command is received to stop the drx_InactivityTimer. FIG. 4 illustrates the physical downlink shared channel (PDSCH) decoding time as well as the savings which could be achieved due to the fact the wireless device stops PDCCH monitoring earlier. The downside of this solution is that the network (e.g., network node) may need to allocate PDCCH resources and as well as PDSCH resources to transmit the MAC CE.

The following definitions provide a limited description of the connected mode DRX variables. The complete list of parameters is available in 3GPP specification such as 3GPP Technical Specification (TS) 38.321.

Drx-onDurationTimer: Time during which the wireless device waits to receive PDCCH after waking up from DRX or monitoring time for the on Duration. The duration at the beginning of a DRX cycle. This phase defines the minimum average awake time of a wireless device; and according to 3GPP TS 38.331, this time value can be configured from 1 to 1600 ms.

Drx-Inactivity Timer: the duration after the PDCCH occasion in which a PDCCH indicates a new uplink (UL) or DL transmission for the MAC entity. The wireless device starts the first inactivity timer supervising the switch to discontinuous reception when it successfully decodes PDCCH for a first transmission (not for retransmissions). If short DRX is configured, the wireless device starts the inactivity timer supervising the switch from short DRX cycles to long DRX cycles when it enters DRX (i.e., at the expiry of the former timer). According to 3GPP TS 38.331, this time value can be configured from 0 to 2560 ms.

DRX cycle: The DRX cycle is defined as the total time of active time and wireless device sleep time. This is also configurable however, there may be a trade-off value between wireless device battery saving and wireless device delay requirement. In 3GPP TS 38.331 for long DRX cycle this value can vary from 10 to 10240 ms and for short DRX cycle this value can vary from 2 to 640 ms.

Active-time: The total time during which the wireless device monitors PDCCH, and it includes the time while the following, for example as described in 3GPP TS 38.321, subclause 5.7:
drx-onDurationTimer or drx-Inactivity Timer configured for the DRX group is running; or
drx-RetransmissionTimerDL or drx-Retransmission TimerUL is running on any Serving Cell in the DRX group; or
ra-ContentionResolutionTimer or msgB-ResponseWindow is running; or
a Scheduling Request is sent on PUCCH and is pending; or
a PDCCH indicating a new transmission addressed to the cell radio network temporary identifier (C-RNTI) of the MAC entity has not been received after successful reception of a Random Access Response for the Random Access Preamble not selected by the MAC entity among the contention-based Random Access Preamble.

The parameters listed above show a view of the DRX operation. DRX operation is more complex and its operation depends on more variables and timers such as one or more of the following:
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDurationTimer in case DCP is monitored but not detected;
ps-Periodic_CSI_Transmit (optional): the configuration to report periodic CSI during the time duration indicated by drx-onDurationTimer in case DCP is configured but associated drx-onDurationTimer is not started;
ps-TransmitPeriodicL1-RSRP (optional): the configuration to transmit periodic L1-RSRP report(s) during the time duration indicated by drx-onDurationTimer in case DCP is configured but associated drx-onDuration Timer is not started.

Hence, the traffic characteristics associated with new types of applications such as XR based application make it difficult to apply existing DRX parameters to optimize both latency and power savings when these new types of applications are used.

### SUMMARY

Some embodiments advantageously provide methods, systems, and apparatuses for discontinuous reception, DRX, sleep during, for example, a DRX active time. One or more embodiments described herein provide methods in both wireless device and network node.

According to one aspect of the present disclosure, a method implemented in a wireless device that is configured to communicate with a network node is provided. The method comprises: receiving an indication to cause the wireless device to, during an active time of a discontinuous reception, DRX, period, enter a sleep state after a physical downlink shared channel, PDSCH, reception at the wireless device; receiving the PDSCH; and entering the sleep state during the active time of the DRX period according to the indication; wherein the indication is included in a physical downlink control channel, PDCCH.

According to another aspect of the present disclosure, a method implemented in a network node that is configured to communicate with a wireless device is provided. The method comprises: transmitting an indication to cause the wireless device to, during an active time of a discontinuous reception, DRX, period, enter a sleep state after a physical downlink shared channel, PDSCH, reception at the wireless device; and transmitting the PDSCH according to the indication; wherein the indication is included in a physical downlink control channel, PDCCH.

According to another aspect of the present disclosure, a wireless device is provided. The wireless device configured to, and/or comprises a radio interface and/or processing circuitry configured to: receive an indication to cause the wireless device to, during an active time of a discontinuous reception, DRX, period, enter a sleep state after a physical downlink shared channel, PDSCH, reception at the wireless device; receive the PDSCH; and enter the sleep state during the active time of the DRX period according to the indication; wherein the indication is included in a physical downlink control channel, PDCCH.

According to another aspect of the present disclosure, a network node is provided. The network node configured to, and/or comprises a radio interface and/or comprising processing circuitry configured to: transmit an indication to cause the wireless device to, during an active time of a discontinuous reception, DRX, period, enter a sleep state after a physical downlink shared channel, PDSCH, reception at the wireless device; and transmit the PDSCH according to the indication; wherein the indication is included in a physical downlink control channel, PDCCH.

Certain embodiments may provide one or more of technical advantages. One technical advantage of embodiments may be that they provide a faster mechanism to terminate the current DRX cycle at the UE side, where terminate may refer to entering a sleep state/mode/period during active time or before expiration of an active time period.

These and other objects, features and advantages of the exemplary embodiments of the present disclosure will become apparent upon reading the following detailed description of the exemplary embodiments of the present disclosure.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a graph of frame latency measured over RAN;

FIG. 2 is a graph of cumulative distribution functions of the number of transport blocks required to deliver a video frame with size ranging from 20 KB to 300 KB;

FIG. 3 is a diagram of a DRX mechanism;

FIG. 4 is a diagram of DRX operation with MAC CE command for DRX;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node according to some embodiments of the present disclosure;

FIG. 12 is a flowchart of an example process in a wireless device according to some embodiments of the present disclosure;

FIG. 13 is a block diagram of an example of an indication to enter a sleep state according to some embodiments of the present disclosure;

FIG. 14 is a block diagram of another example of an indication to enter a sleep state according to some embodiments of the present disclosure;

FIG. 15 is a block diagram of yet another example of example of an indication to enter a sleep state according to some embodiments of the present disclosure;

FIG. 16 is a block diagram of yet another example of example of an indication to enter a sleep state according to some embodiments of the present disclosure;

FIG. 17 is a block diagram of an example of example of an indication to enter a sleep state in a multi-slot resource allocation according to some embodiments of the present disclosure; and

FIG. 18 is a block diagram of another example of example of an indication to enter a sleep state in a multi-slot resource allocation according to some embodiments of the present disclosure.

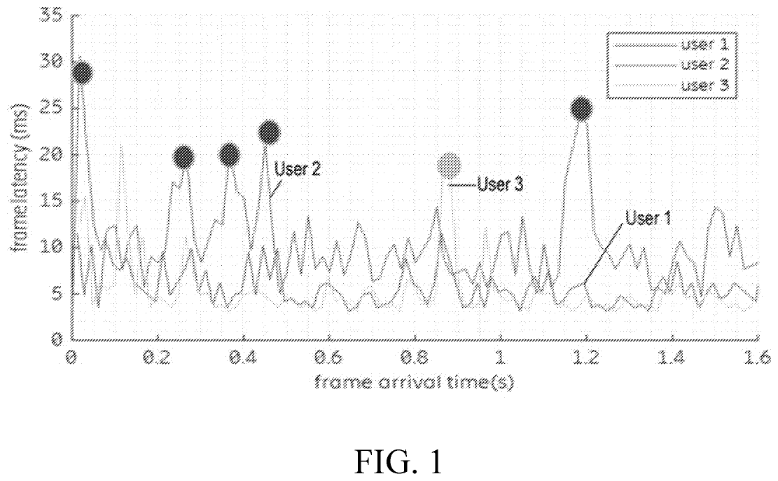

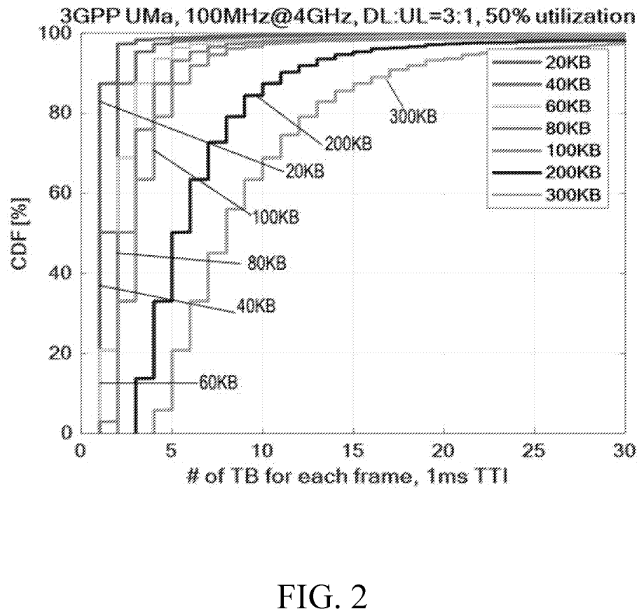

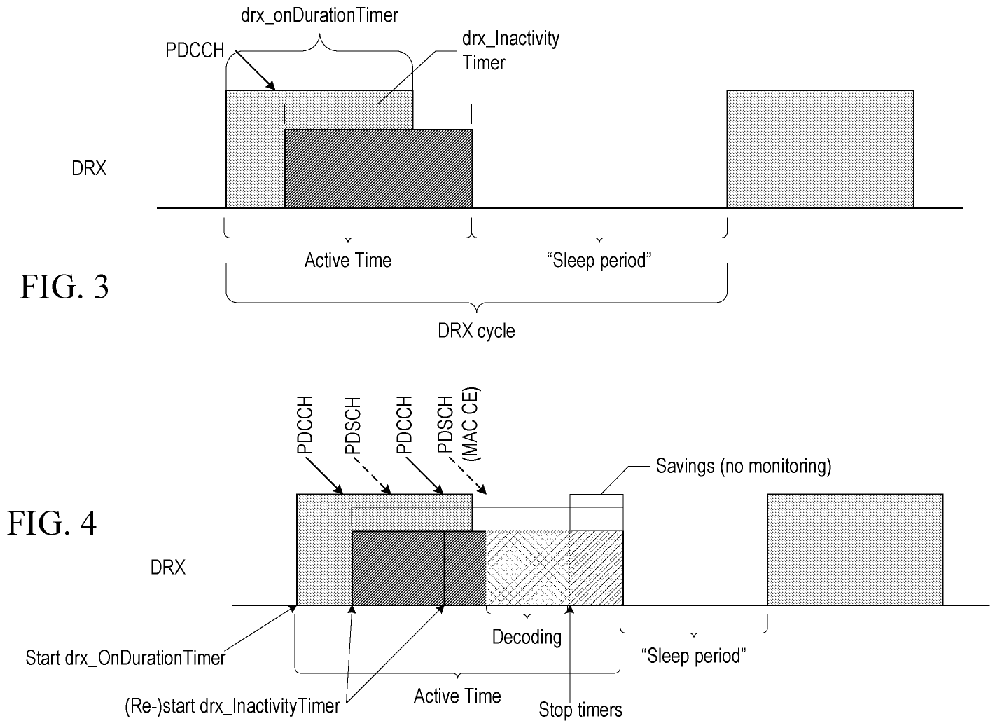

### DETAILED DESCRIPTION

As discussed above, XR traffic and, especially video traffic, is characterized by periodic, large and variable application PDUs size. In addition, XR application may additionally have other type of traffic such as voice, or control messages. There may also be some jitter which results in that the data may come slightly earlier or later than expected. On the other hand, the data arrives in a confined window time. All that results in that it is difficult to find a set of DRX parameters that optimize both latency and energy savings for XR traffic.

The drx_Inactivity Timer allows for an additional time, on top of the drx_OnDurantionTimer, in which the wireless device monitors for PDCCH. This first timer was introduced at least in part because enhanced Mobile Broadband (eMBB) applications typically transmit bursts of traffic aperiodically. Thus, it is expected that after a first burst of data, a second burst arrives shortly. drx_Inactivity Timer aims at covering this second burst of data. It also provides the scheduler with flexibility to decide when to schedule transmissions. The use of MAC CEs also makes more sense for eMBB as the traffic arrival is uncertain so different strategies to move the wireless device to the sleep state may be used.

For XR traffic, very aggressive, i.e., short DRX timers may lead to that data arrives when the wireless device is not monitoring PDCCH. Short DRX cycles also negatively affects the network since it imposes hard requirements to the scheduler. In high load scenarios, it may not always be possible to serve during the “on duration” all those wireless devices with very short DRX timers. On the other hand, long DRX timers provide a lot more flexibility to the network to schedule data; thus, prioritizing its own resources in the best possible way. The drawback is that power consumption increases at the wireless device due to the fact that the wireless device will need to monitor PDCCH for a long period even if all the data has already been transmitted to that wireless device.

DRX timers are configured by RRC and their duration remains to be fixed until a new RRC reconfiguration occurs. MAC CE commands can assist to move the wireless device to the “sleep period” or to change between DRX modes. However, MAC CEs are transmitted in the PDSCH which requires PDCCH resources and they take time to decode at the wireless device. In addition, when every signaling XR application packet has a different size, it may not be acceptable to signal MAC CEs 10 whenever there are new application packets. The reason is that PDCCH and PDSCH signaling overhead for MAC CE is linearly increasing to the frequency of XR packet generation which can be from 1/120 second to 1/30 second depending on a refresh rate in video applications in XR. This excessive signaling overhead of MAC CE to adaptively reduce active time to save wireless devices power consumption may lead to new solutions for low-overhead and fast active time reduction.

Before describing in detail example embodiments, it is noted that the embodiments reside primarily in combinations of apparatus components and processing steps related to DRX sleep during, for example, a DRX active time. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

As used herein, “sleep” may refer to a low power mode where power consumed is less than a non-DRX mode and/or may refer to a period when PDSCH is not monitored and/or a period during an active time (e.g., ON time) when monitoring is not performed, and may also be referred to as sleep period, sleep state, etc.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide DRX sleep during, for example, a DRX active time. A faster mechanism is provided to terminate the current DRX cycle at the UE side. This may be done by using an indication in PDCCH or PDSCH corresponding to the last MAC PDU in e.g. a MAC CE.

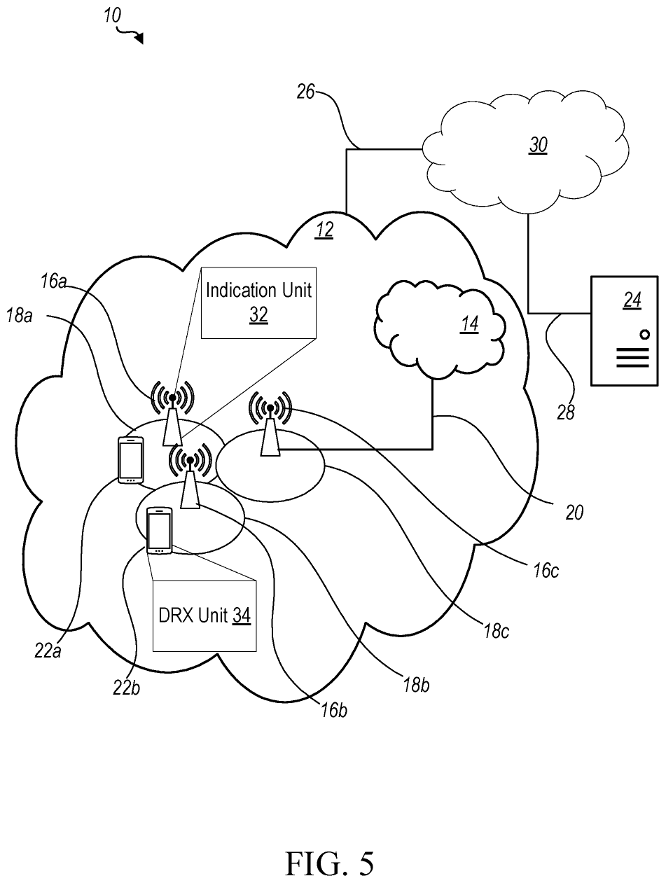

Referring again to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node 16 functions as described herein such as with respect to DRX sleep during, for example, a DRX active time. A wireless device 22 is configured to include a DRX unit 34 which is configured to perform one or more wireless device 22 functions as described herein such as with respect to DRX sleep during, for example, a DRX active time.

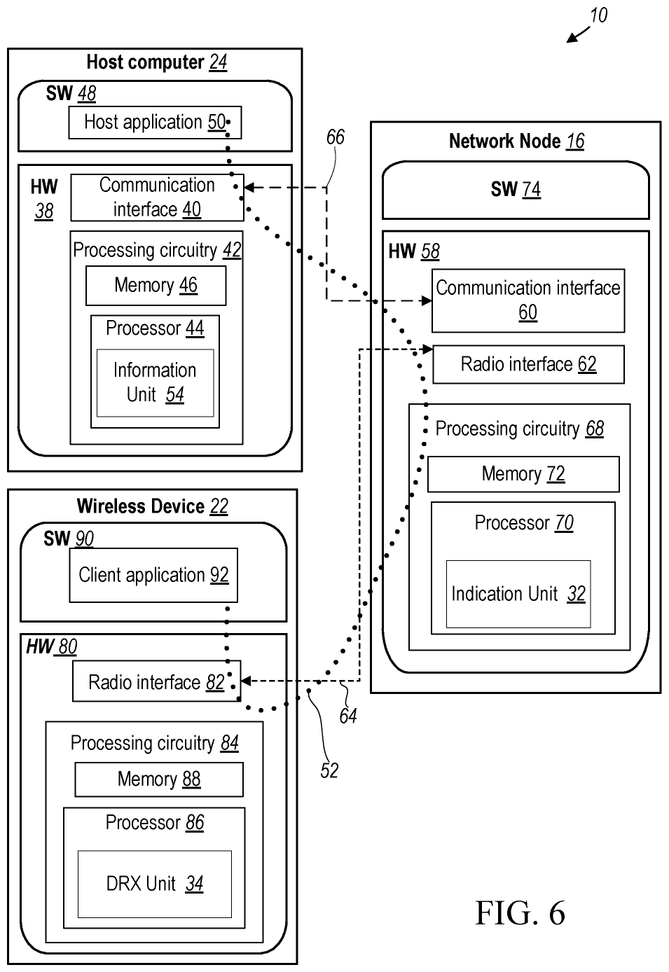

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to determine, forward, transmit, receive, relay, indicate, store, etc. information related to DRX sleep during, for example, a DRX active time.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to perform one or more network node 16 functions as described herein such as with respect to DRX sleep during, for example, a DRX active time.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a DRX unit 34 configured to perform one or more wireless device 22 functions as described herein such as with respect to DRX sleep during, for example, a DRX active time.

In some embodiments, the inner workings of the network node 16, WD 22, and host computer 24 may be as shown in FIG. 6 and independently, the surrounding network topology may be that of FIG. 5.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as indication unit 32, and DRX unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

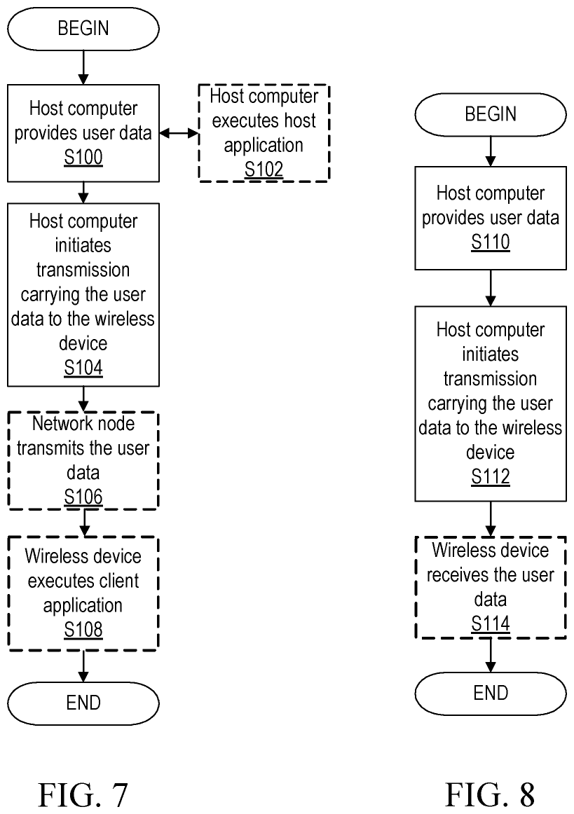

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

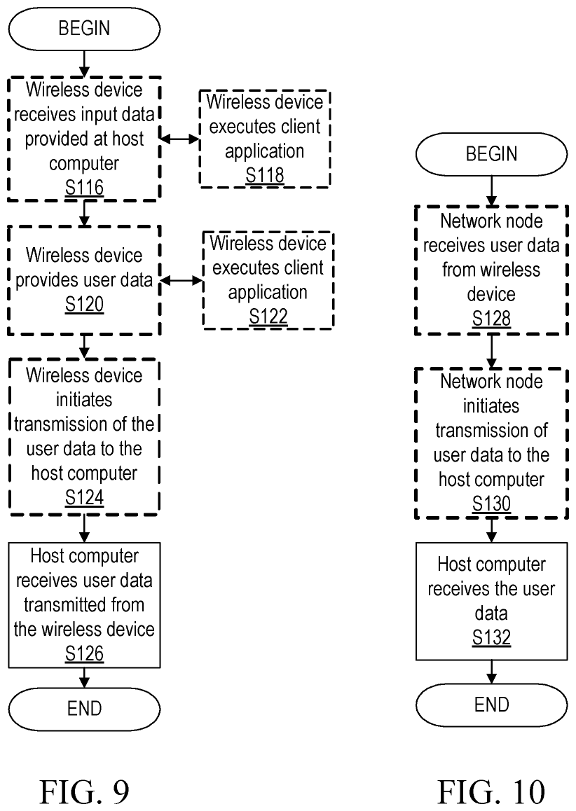

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

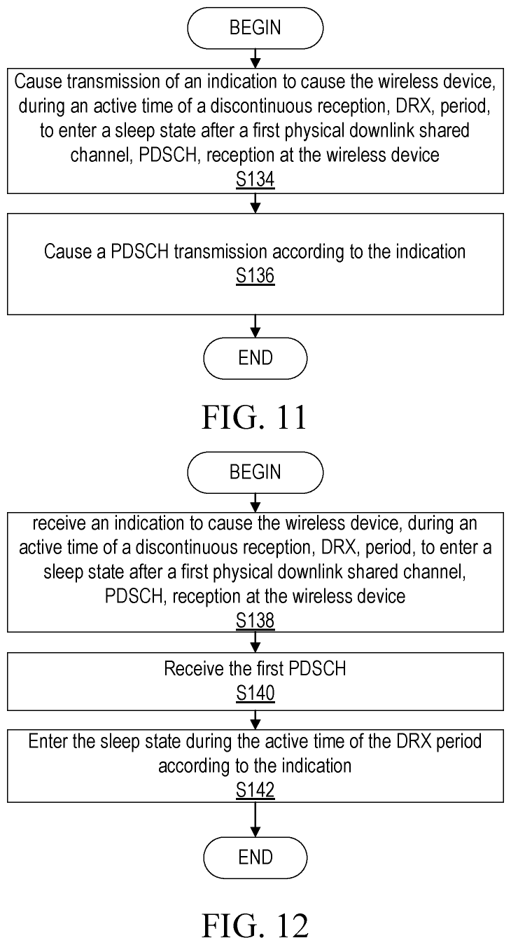

FIG. 11 is a flowchart of an example process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to cause (Block S134) transmission of an indication to cause the wireless device, during an active time of a discontinuous reception, DRX, period, to enter a sleep state after a first physical downlink shared channel, PDSCH, reception at the wireless device 22, as described herein. Network node 16 is configured to cause (Blocks S136) a PDSCH transmission according to the indication, as described herein.

According to one or more embodiments, the indication is configured to indicate for the wireless device 22 to one of not start and re-start a DRX inactivity timer in the DRX period, and indicate for the wireless device 22 to enter a sleep state after receiving the indication and enter an active state before the first PDSCH reception. According to one or more embodiments, the indication is configured to: indicate for the wireless device 22 to stop a DRX ON duration timer; and indicate for the wireless device 22 to enter a sleep state after receiving the indication and enter an active state before the first PDSCH reception.

According to one or more embodiments, the indication is further configured to indicate a time after receiving the indication from which the wireless device is to enter a sleep state. According to one or more embodiments, the first PDSCH reception refers to a PDSCH reception. The PDSCH reception corresponds to a last PDSCH reception, in time, of a plurality of PDSCH receptions received during the DRX period. According to one or more embodiments, the indication is included in a physical downlink control channel, PDCCH.

FIG. 12 is a flowchart of an example process in a wireless device 22 according to some embodiments of the present disclosure. One or more blocks described herein may be performed by one or more elements of wireless device 22 such as by one or more of processing circuitry 84 (including the DRX unit 34), processor 86, radio interface 82 and/or communication interface 60. Wireless device 22 is configured to receive (Block S138) an indication to cause the wireless device 22, during an active time of a discontinuous reception, DRX, period, to enter a sleep state after a first physical downlink shared channel, PDSCH, reception at the wireless device 22, as described herein. Wireless device 22 is configured to receive (Block S140) the first PDSCH, as described herein. Wireless device 22 is configured to enter (Block S142) the sleep state during the active time of the DRX period according to the indication, as described herein. According to one or more embodiments, the first PDSCH reception refers to a PDSCH reception.

According to one or more embodiments, the indication is configured to: indicate for the wireless device to one of not start and re-start a DRX inactivity timer in the DRX period, and indicate for the wireless device to enter a sleep state after receiving the indication and enter an active state before the first PDSCH reception. According to one or more embodiments, the indication is configured to: indicate for the wireless device 22 to stop the DRX ON duration timer, and indicate for the wireless device 22 to enter a sleep state after receiving the indication and enter an active state before the first PDSCH reception.

According to one or more embodiments, the indication is further configured to indicate a time after receiving the indication from which the wireless device 22 is to enter a sleep state. According to one or more embodiments, the processing circuitry is further configured to receive a plurality of PDSCH receptions during the DRX period where the first PDSCH reception corresponds to a last PDSCH reception, in time, of the plurality of PDSCH receptions. According to one or more embodiments, the indication is included in a physical downlink control channel, PDCCH.

Having described the general process flow of arrangements of the disclosure and having provided examples of hardware and software arrangements for implementing the processes and functions of the disclosure, the sections below provide details and examples of arrangements for such as with respect to DRX sleep during, for example, a DRX active time.

One or more network node 16 functions described herein may be performed by one or more of processing circuitry 68, processor 70, indication unit 32, radio interface 62, etc. One or more wireless device 22 function described herein may be performed by one or more of processing circuitry 84, processor 86, DRX unit 34, radio interface 82, etc.

Some embodiments provide, such as with respect to DRX sleep during, for example, a DRX active time.

One or more embodiments described herein provide a faster mechanism to terminate the current DRX cycle at the wireless device side as compared with known solutions, where terminate may refer to entering a sleep state/mode/period during active time or before expiration of an active time period. This can be performed, for example, by using an indication in PDCCH or PDSCH corresponding to the last MAC PDU in, e.g., a MAC CE. For example, a last MAC protocol data unit (PDU) may correspond to a last MAC PDU in time and/or frequency in a MAC CE.

In one or more embodiments, a network node transmits a command or specific timing information in PDCCH or PDSCH to indicate to the wireless device to return to or enter the sleep period.

### Solution 1:1-Slot Resource Allocation PDCCH

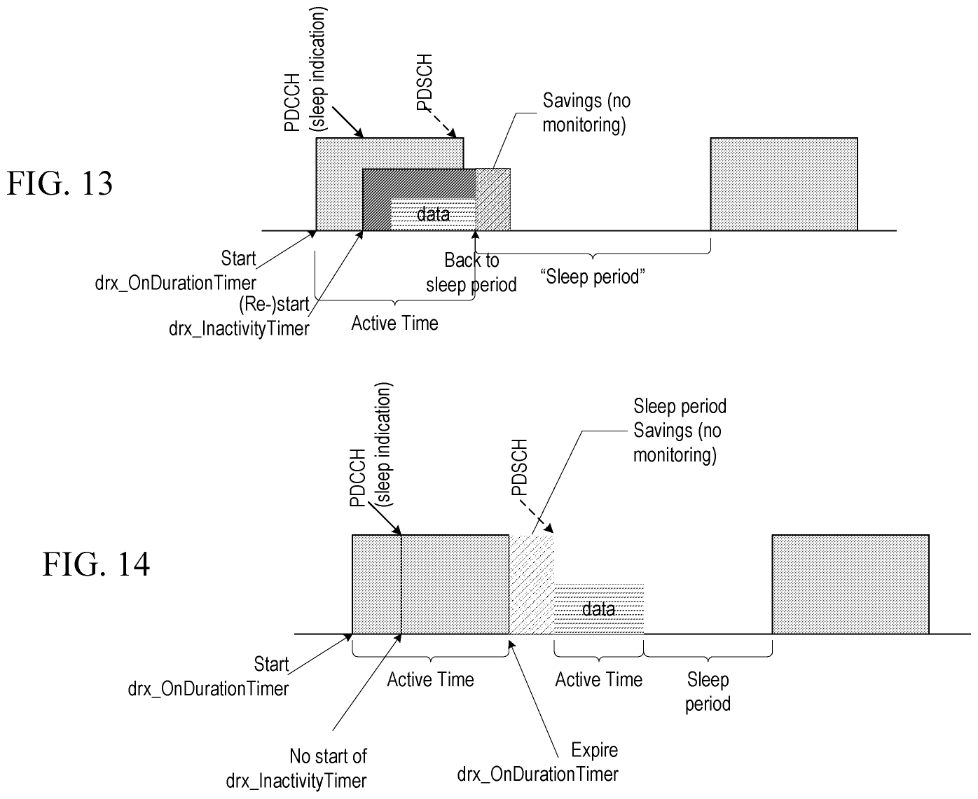

In this case, when the network node 16 allocates resources to the wireless device 22 at most within 1 slot, the PDCCH may include an indication which will command (e.g., initiate, instruct, etc.) the wireless device 22 to return to the sleep state after the PDSCH corresponding reception. This will result in that the wireless device 22 is able to stop the drx_Inactivity Timer and the drx_OnDuration Timer if they were running, as illustrated in the example of FIG. 13.

In cases where the PDCCH transmission is not closely followed by the PDSCH, there are some options, described herein, to minimize the active time between those two DL signals.

Additionally, the PDCCH command could also indicate to the wireless device 22 to not start or re-start the drx_Inactivity Timer in this DRX period. In this case, the wireless device 22 may have to return to the monitoring period when the PDSCH is expected even if the drx_Inactivity Timer or the drx_OnDurationTimer expired before the PDSCH was received. The wireless device 22 would then receive the PDSCH and return to the sleep mode as illustrated in the example of FIG. 14. As illustrated in FIG. 14, the wireless device 22 receives an indication (e.g., PDCCH command) which indicates it to not start of the drx_Inactivity Timer, then the wireless device 22 enters the sleep state as drx_OnDurationTimer expires. The indication could further indicate the wireless device 22 to re-start the drx_Inactivity Timer in this DRX period so the wireless device 22 would then enter an active state again to receive any scheduled PDSCH. After the last indicated PDSCH reception, the wireless device 22 would return to the sleep mode.

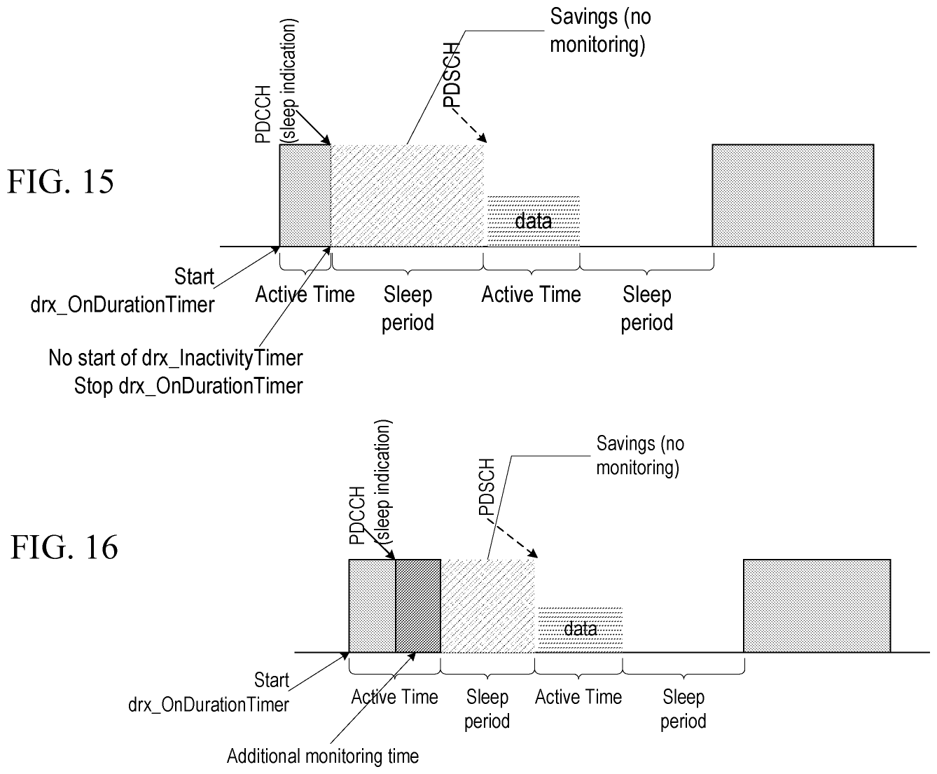

Additionally to the above, the PDCCH command could also indicate to the wireless device 22 to stop the drx_OnDurationTimer. In this case, the wireless device 22 may have to return to the sleep period after the reception of the PDCCH as both drx_Inactivity Timer and the drx_OnDurationTimer would not be running. The wireless device 22 would, however, wake up to receive any PDSCH scheduled before the last indicated PDSCH after which the wireless device 22 would return to the sleep mode, as illustrated in the example of FIG. 15. After the last indicated PDSCH reception, the wireless device 22 would return to the sleep mode. In case the wireless device 22 does not stop the drx_OnDurationTimer since the wireless device 22 knows the exact time in which the PDSCH(s) will be received, the wireless device 22 could be allowed to/or may go to the sleep period as described above.

Another example solution maximizes reducing the “Active Time” and achieves higher battery savings at the wireless device as compared with known solutions.

In another option, as compared to the previously described option, (no starting the drx-Inactivity Timer or stopping the drx_OnDurationTimer), the network node 16 could also indicate a time difference from which a wireless device 22 may fall to sleep from the moment of PDCCH reception. The indication in PDCCH can be implemented in DCI by either introducing one or more new fields or reusing existing fields in the DCI. In this case, the drx_Inactivity Timer may take the value indicated in PDCCH, or another timer could be started at the wireless device 22 as illustrated in FIG. 16.

Another option to indicate to the wireless device that it should go to the sleep period after the reception of the PDSCH, instead of using the PDCCH as described above, a medium access control (MAC) subheader may be transmitted in the MAC PDU (e.g., protocol data unit) transmitted in the last PDSCH. As a non-limiting example, when a network node 16 does not have any more date for initial transmission, it marks some fields in MAC subheader to indicate a wireless device 22 that it should go to a sleep mode at a certain point of time since there is no more data to be scheduled.

### Solution 2: Multi-Slot Resource Allocation PDCCH

For multi-slot resource allocation, the previous description under solution 1 still applies. When PDCCH indicates multiple resource allocation, the network node 16 may transmit a PDSCH in multiple points in time/frequency.

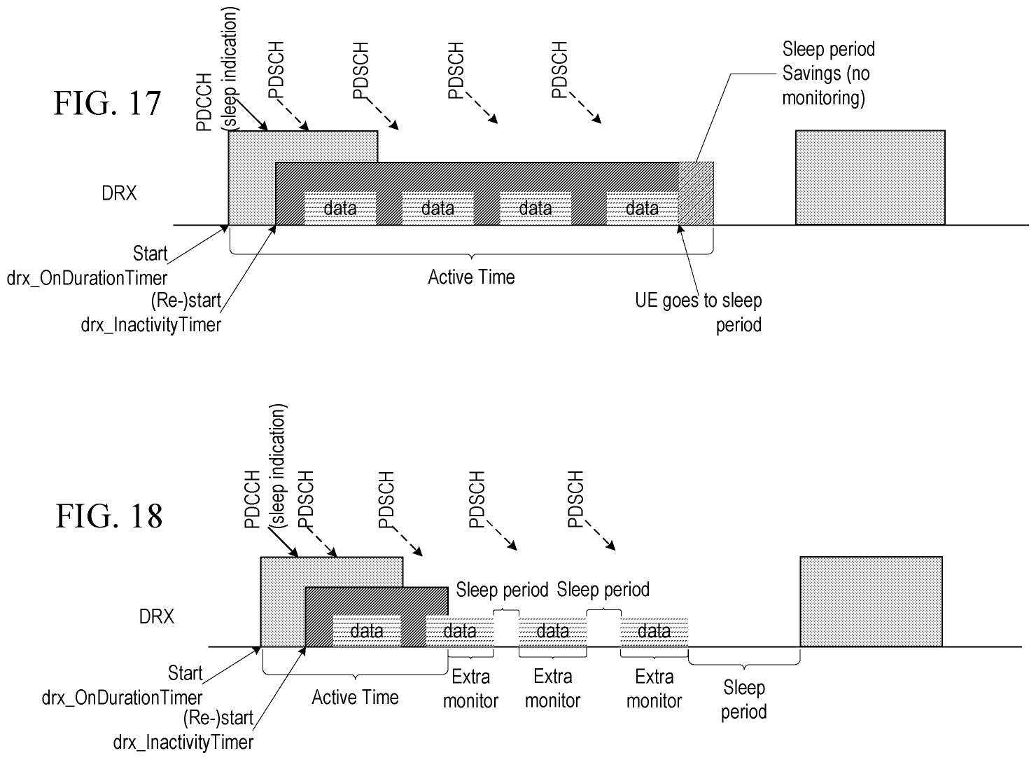

In this case, when PDCCH includes the indication to command the wireless device 22 to go to the sleep state, the wireless device 22 may do so after the reception of the last PDSCH indicated in the PDCCH. This may result in that the wireless device 22 stops the drx Inactivity Timer and the drx_OnDuration Timer if they were running as illustrated in FIG. 17.

It may be likely that the drx_Inactivity Timer is configured with a small value due to the impact it has in the wireless device 22 power consumption. However, this may create an issue to the multi-slot scheduling. It may also be the case in which the drx_Inactivity Timer and/or the drx_OnDurationTimer expire while PDSCH transmissions have not yet be transmitted to the wireless device 22. In this case, the wireless device 22 may always return to the monitoring period to receive the PDSCH transmissions, as illustrated in FIG. 18, based on the indicated timing information from a network node 16. When the last PDSCH is received, as before, the wireless device 22 will enter the sleeping period. It is also possible for a wireless device 22 to go to sleep for a short period of time in the gap between two PDSCH receptions based on a network node 16 indication to further save energy.

Hence, in one or more embodiments, the wireless device battery consumption is minimized so that the wireless device is only active during the time data is expected without any separate PDCCH and/or PDSCH signaling for MAC-CE signaling. Other times, the wireless device is immediately sent to sleep. For multi-slot allocation scheduling, one or more embodiments, at least help reduce the dependency with the drx_Inactivity Timer since it may not be possible to find a suitable value that addressed both multi-slot scheduling and 1-slot scheduling.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
AR Augmented Reality
CN Core Network
DL Downlink
DRX Discontinuous Reception
eMBB enhanced Mobile Broadband
Fps Frames Per Second
HMD Head Mounted Display
IP Internet Protocol
KB Kilobytes
LTE Long Term Evolution
MAC Medium Access Control
MAC CE MAC Control Element
NR New Radio
PDCCH Physical Downlink Control Channel
PDSCH Physical Downlink Shared Channel
RAN Radio Access Network
RRC Radio Resource Control
SI Study Item
TB Transport Block
TTI Transmission Time Interval
UE User Equipment
UL Uplink
WI Work Item
XR extended Reality

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EMBODIMENTS

Embodiment A1. A network node configured to communicate with a wireless device, the network node configured to, and/or comprising a radio interface and/or comprising processing circuitry configured to:
cause transmission of an indication to cause the wireless device, during an active time of a discontinuous reception, DRX, period, to enter a sleep state after a first physical downlink shared channel, PDSCH, reception at the wireless device; and
cause a PDSCH transmission according to the indication.

Embodiment A2. The network node of Embodiment A1, wherein the indication is configured to:
indicate for the wireless device to one of not start and re-start a DRX inactivity timer in the DRX period; and
indicate for the wireless device to enter a sleep state after receiving the indication and enter an active state before the first PDSCH reception.

Embodiment A3. The network node of Embodiment A1, wherein the indication is configured to:
indicate for the wireless device to stop a DRX ON duration timer; and
indicate for the wireless device to enter a sleep state after receiving the indication and enter an active state before the first PDSCH reception.

Embodiment A4. The network node of Embodiment A1, wherein the indication is further configured to indicate a time after receiving the indication from which the wireless device is to enter a sleep state.

Embodiment A5. The network node of Embodiment A1, wherein the first PDSCH reception corresponds to a last PDSCH reception, in time, of a plurality of PDSCH receptions receiving during the DRX period.

Embodiment A6. The network node of Embodiment A1, wherein the indication is included in a physical downlink control channel, PDCCH.

Embodiment B1. A method implemented in a network node that is configured to communicate with a wireless device, the method comprising:
causing transmission of an indication to cause the wireless device, during an active time of a discontinuous reception, DRX, period, to enter a sleep state after a first physical downlink shared channel, PDSCH, reception at the wireless device; and
causing a PDSCH transmission according to the indication.

Embodiment B2. The method of Embodiment B1, wherein the indication is configured to:
indicate for the wireless device to one of not start and re-start a DRX inactivity timer in the DRX period; and
indicate for the wireless device to enter a sleep state after receiving the indication and enter an active state before the first PDSCH reception.

Embodiment B3. The method of Embodiment B1, wherein the indication is configured to:
indicate for the wireless device to stop a DRX ON duration timer; and
indicate for the wireless device to enter a sleep state after receiving the indication and enter an active state before the first PDSCH reception.

Embodiment B4. The method of Embodiment B1, wherein the indication is further configured to indicate a time after receiving the indication from which the wireless device is to enter a sleep state.

Embodiment B5. The method of Embodiment B1, wherein the first PDSCH reception corresponds to a last PDSCH reception, in time, of a plurality of PDSCH receptions receiving during the DRX period.

Embodiment B6. The method of Embodiment B1, wherein the indication is included in a physical downlink control channel, PDCCH.

Embodiment C1. A wireless device configured to communicate with a network node, the WD configured to, and/or comprising a radio interface and/or processing circuitry configured to:
receive an indication to cause the wireless device, during an active time of a discontinuous reception, DRX, period, to enter a sleep state after a first physical downlink shared channel, PDSCH, reception at the wireless device;
receive the first PDSCH; and
enter the sleep state during the active time of the DRX period according to the indication.

Embodiment C2. The wireless device of Embodiment C1, wherein the indication is configured to:
indicate for the wireless device to one of not start and re-start a DRX inactivity timer in the DRX period; and
indicate for the wireless device to enter a sleep state after receiving the indication and enter an active state before the first PDSCH reception.

Embodiment C3. The wireless device of Embodiment C1, wherein the indication is configured to:
indicate for the wireless device to stop the DRX ON duration timer; and
indicate for the wireless device to enter a sleep state after receiving the indication and enter an active state before the first PDSCH reception.

Embodiment C4. The wireless device of Embodiment C1, wherein the indication is further configured to indicate a time after receiving the indication from which the wireless device is to enter a sleep state.

Embodiment C5. The wireless device of Embodiment C1, wherein the processing circuitry is further configured to receive a plurality of PDSCH receptions during the DRX period, the first PDSCH reception corresponding to a last PDSCH reception, in time, of the plurality of PDSCH receptions.

Embodiment C6. The wireless device of Embodiment C1, wherein the indication is included in a physical downlink control channel, PDCCH.

Embodiment D1. A method implemented in a wireless device that is configured to communicate with a network node, the method comprising:
receiving an indication to cause the wireless device, during an active time of a discontinuous reception, DRX, period, to enter a sleep state after a first physical downlink shared channel, PDSCH, reception at the wireless device;
receiving the first PDSCH; and
entering the sleep state during the active time of the DRX period according to the indication.

Embodiment D2. The method of Embodiment D1, wherein the indication is configured to:
indicate for the wireless device to one of not start and re-start a DRX inactivity timer in the DRX period; and
indicate for the wireless device to enter a sleep state after receiving the indication and enter an active state before the first PDSCH reception.

Embodiment D3. The method of Embodiment D1, wherein the indication is configured to:
indicate for the wireless device to stop the DRX ON duration timer; and
indicate for the wireless device to enter a sleep state after receiving the indication and enter an active state before the first PDSCH reception.

Embodiment D4. The method of Embodiment D1, wherein the indication is further configured to indicate a time after receiving the indication from which the wireless device is to enter a sleep state.

Embodiment D5. The method of Embodiment D1, further comprising receiving a plurality of PDSCH receptions during the DRX period, the first PDSCH reception corresponding to a last PDSCH reception, in time, of the plurality of PDSCH receptions.

Embodiment D6. The method of Embodiment D1, wherein the indication is included in a physical downlink control channel, PDCCH.

1. A method implemented in a wireless device that is configured to communicate with a network node, the method comprising:
receiving an indication to cause the wireless device to, during an active time of a discontinuous reception, DRX, period, enter a sleep state after a physical downlink shared channel, PDSCH, reception at the wireless device;
receiving the PDSCH;
entering the sleep state during the active time of the DRX period according to the indication; and
the indication being included in a physical downlink control channel, PDCCH.

2. The method of claim 1, wherein the indication is configured to:
indicate for the wireless device to one of not start and re-start a DRX inactivity timer in the DRX period; and
indicate for the wireless device to enter the sleep state after receiving the indication and enter an active state before the PDSCH reception.

3. The method of claim 1, wherein the indication is configured to:
indicate for the wireless device to stop a DRX ON duration timer; and
indicate for the wireless device to enter the sleep state after receiving the indication and enter an active state before the PDSCH reception.

4. The method of claim 1, wherein the indication is further configured to indicate a time after receiving the indication from which the wireless device is to enter the sleep state.

5. The method of claim 1, further comprising receiving a plurality of PDSCHs during the DRX period, wherein said received PDSCH is a last PDSCH, in time, of the plurality of PDSCHs.

6. A method implemented in a network node that is configured to communicate with a wireless device, the method comprising:
transmitting an indication to cause the wireless device to, during an active time of a discontinuous reception, DRX, period, enter a sleep state after a physical downlink shared channel, PDSCH, reception at the wireless device;
transmitting the PDSCH according to the indication; and
the indication being included in a physical downlink control channel, PDCCH.

7. The method of claim 6, wherein the indication is configured to:
indicate for the wireless device to one of not start and re-start a DRX inactivity timer in the DRX period; and
indicate for the wireless device to enter the sleep state after receiving the indication and enter an active state before the PDSCH reception.

8. The method of claim 6 or 7, wherein the indication is configured to:
indicate for the wireless device to stop a DRX ON duration timer; and
indicate for the wireless device to enter the sleep state after receiving the indication and enter an active state before the PDSCH reception.

9. The method of claim 6, wherein the indication is further configured to indicate a time after receiving the indication from which the wireless device is to enter the sleep state.

10. The method of claim 6, further comprising transmitting a plurality of PDSCHs during the DRX period, wherein said transmitted PDSCH is a last PDSCH, in time, of the plurality of PDSCHs during the DRX period.

11. A wireless device configured to communicate with a network node, the wireless device one of more of configured to, comprising a radio interface configure to and processing circuitry configured to:
receive an indication to cause the wireless device to, during an active time of a discontinuous reception, DRX, period, enter a sleep state after a physical downlink shared channel, PDSCH, reception at the wireless device;
receive the PDSCH;
enter the sleep state during the active time of the DRX period according to the indication; and
the indication being included in a physical downlink control channel, PDCCH.

12. The wireless device of claim 11, wherein the indication is configured to:
indicate for the wireless device to one of not start and re-start a DRX inactivity timer in the DRX period; and
indicate for the wireless device to enter the sleep state after receiving the indication and enter an active state before the PDSCH reception.

13. The wireless device of claim 11, wherein the indication is configured to:
indicate for the wireless device to stop a DRX ON duration timer; and
indicate for the wireless device to enter the sleep state after receiving the indication and enter an active state before the PDSCH reception.

14. The wireless device of claim 11, wherein the indication is further configured to indicate a time after receiving the indication from which the wireless device is to enter the sleep state.

15. The wireless device of claim 11, wherein the processing circuitry is further configured to receive a plurality of PDSCHs during the DRX period, wherein said received PDSCH is a last PDSCH, in time, of the plurality of PDSCHs.

16. A network node configured to communicate with a wireless device, the network node one or more of configured to, and comprising a radio interface configured to and comprising processing circuitry configured to:
transmit an indication to cause the wireless device to, during an active time of a discontinuous reception, DRX, period, enter a sleep state after a physical downlink shared channel, PDSCH, reception at the wireless device;
transmit the PDSCH according to the indication; and
the indication being included in a physical downlink control channel, PDCCH.

17. The network node of claim 16, wherein the indication is configured to:
indicate for the wireless device to one of not start and re-start a DRX inactivity timer in the DRX period; and
indicate for the wireless device to enter the sleep state after receiving the indication and enter an active state before the PDSCH reception.

18. The network node of claim 16, wherein the indication is configured to:
indicate for the wireless device to stop a DRX ON duration timer; and
indicate for the wireless device to enter the sleep state after receiving the indication and enter an active state before the PDSCH reception.

19. The network node of claim 16, wherein the indication is further configured to indicate a time after receiving the indication from which the wireless device is to enter the sleep state.

20. The network node of claim 16, the processing circuitry is further configured to transmit a plurality of PDSCHs during the DRX period, wherein said transmitted PDSCH is a last PDSCH, in time, of a plurality of PDSCHs during the DRX period.
